(19) United States
(12) Patent Application Publication
(10) Pub. No.: US 2013/0076918 A1
(43) Pub. Date: Mar. 28, 2013

(54) METHOD FOR CONTROLLING CAMERA USING TERMINAL AND TERMINAL THEREOF

(71) Applicants: Hyungshin PARK, Yongin-Si (KR); Seunghyun Kim, Anyang-Si (KR); Seokbyung Oh, Seoul (KR)

(72) Inventors: Hyungshin PARK, Yongin-Si (KR); Seunghyun Kim, Anyang-Si (KR); Seokbyung Oh, Seoul (KR)

(21) Appl. No.: 13/340,655

(22) Filed: Dec. 29, 2011

(30) Foreign Application Priority Data
Sep. 23, 2011 (KR) 10-2011-0096568

(51) Int. Cl. H04N 5/225

(52) U.S. Cl. 348/207.11; 348/E05.024

(57) ABSTRACT

A method of controlling a mobile terminal, and which includes establishing a wireless communication connection with an external camera located at a near distance from the mobile terminal; receiving, by the mobile terminal and from the external camera, a preview picture generated by the external camera; displaying, on a display unit of the mobile terminal, the preview picture generated by the external camera; receiving an input on the mobile terminal for commanding the external camera to perform a predetermined camera function; and transmitting, by the mobile terminal, the input to the external camera for commanding the external camera to perform the predetermined camera function.

### CROSS REFERENCE TO A RELATED APPLICATION

Pursuant to 35 U.S.C. §119(a), this application claims the benefit of Korean Application No. 10-2011-0096568, filed on Sep. 23, 2011, the contents of which are incorporated by reference herein in their entirety.

### BACKGROUND OF THE INVENTION

1. Field of the Invention

The present disclosure relates to a method of controlling a camera using a terminal and terminal using the same method.

2. Description of the Related Art

In general, digital cameras are mainly used to capture an object through a lens, but in recent years multi-functional, multi-purpose cameras are on the market and commercialized as communication technologies and digital camera fabrication technologies are rapidly developed.

Currently commercialized cameras typically provide various functions such as playing games or multimedia files, transmitting and receiving image data using e-mails or social network services (SNSs), editing images, and the like as well as capturing objects, and in recent years a communication function for transmitting images that have been captured by various terminals has been added to those cameras.

FIG. 1 is a view illustrating the structure of a digital camera in the related art. In particular, FIG. 1A illustrates a front surface of the digital camera 100 and FIG. 1B illustrates a rear surface of the digital camera 100.

Referring to FIG. 1, the digital camera 100 in the related art includes a body 110, a lens 120 located at a front surface of the body 110 to capture an image, a display unit 130 located at a rear surface of the body 110 to display the image captured by the lens 120, and a shutter 140 for generating an input for taking the image captured by the lens 120.

In this manner, according to the related art digital camera 100, the lens 120 and the display unit 130 for displaying an image captured by the lens 120 are located at a front surface and a rear surface of the body 110, respectively. Accordingly, when a user's face, which is not an object, is directly taken, the user has to look at the lens 120, and thus the user cannot directly check the captured image on the display unit 130 to take it with the right composition.

For this purpose, a method of taking an image by adding a timer function has been used when the user wants to take his or her own face, but the foregoing method also does not allow the user to directly check the captured image, and thus there is a limit in controlling a focus or taking an image of his or her desired composition.

### SUMMARY OF THE INVENTION

An object of the present disclosure is to provide a method of controlling to select an image desired to be taken by a camera using a terminal by transmitting an image captured by the camera in real time to the user terminal and terminal using the same method.

Furthermore, another object of the present disclosure is to provide a method of controlling the image taking of a camera using a terminal through a communication means between the camera and the terminal and terminal using the same method.

According to a camera control method disclosed herein, there is provided a camera control method using a mobile terminal, and the method may include establishing a connection for wireless communication with a camera located at a near distance, receiving a picture being captured by the camera from the camera, displaying the received picture, and transmitting an input to the camera when an input for controlling the taking of the displayed picture is generated.

The step of displaying the received picture may display only a partial region corresponding to a pixel size supported by the display unit of the terminal to be stored in the camera after taking the picture within the entire region of the received picture.

Furthermore, the input may be an input for vertically or horizontally moving the displayed picture to select the partial region within the entire region of the received picture.

Furthermore, the input may be an input for changing a capture mode including a shutter speed of the camera, an aperture value, and light sensitivity information (ISO).

Furthermore, the input may be an input for instructing the taking of the displayed picture, and the method may further include receiving a picture taken by the camera.

Furthermore, according to a terminal disclosed herein there is provided a mobile terminal, and the mobile terminal may include a communication unit configured to establish a connection for wireless communication with a camera located at a near distance, receive a picture being captured by the camera from the camera, and transmit an input for controlling the taking of the received picture to the camera, a display unit configured to display the received picture, an input unit configured to generate the input, and a controller configured to control the communication unit to receive the picture from the camera, control the display unit to display the received picture, and control the communication unit to transmit an input to the camera when the input is generated from the input unit.

Furthermore, the display unit may display only a partial region corresponding to a pixel size supported by the display unit to be stored in the camera after taking the picture within the entire region of the received picture.

Furthermore, the input unit may generate an input for vertically or horizontally moving the displayed picture to select the partial region within the entire region of the received picture.

Furthermore, according to a camera control method disclosed herein, there is provided a camera control method using a terminal, and the method may include establishing a connection for wireless communication with a mobile terminal located in a near field region, transmitting a picture being captured by a capture unit to the terminal, receiving an input for controlling the taking of the picture from the terminal, and taking the picture to store it as an image file when the input is an input for instructing the taking of the picture.

Furthermore, the input may be an input for selecting a partial region corresponding to a pixel size supported by the display unit of the terminal desired to be stored as an image file in the camera within the entire region of the picture.

Furthermore, the input may be an input for changing a capture mode including a shutter speed of the capture unit, an aperture value, and light sensitivity information (ISO).

According to a camera control method using a terminal disclosed herein and terminal using the same method, a picture captured by the camera can be transmitted to the terminal to allow a user to directly check the picture in the terminal and select a region desired to be taken, thereby allowing a picture of the right composition to be taken.

Furthermore, according to a camera control method using a terminal disclosed herein and terminal using the same method, various capture modes of the camera can be controlled through the terminal to remotely control image taking without extra physical control of the camera, thereby conveniently performing a picture taking operation.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view illustrating a digital camera in the related art;

FIG. 2 is a block diagram illustrating a camera according to an embodiment disclosed herein;

FIG. 3 is a block diagram illustrating a terminal according to an embodiment disclosed herein;

FIG. 4 is a flow chart illustrating a camera control method using a terminal according to an embodiment disclosed herein;

FIG. 5 is a view illustrating an example in which a terminal according to an embodiment disclosed herein receives an image from a camera; and

FIG. 6 is a view illustrating an example in which a terminal according to an embodiment disclosed herein displays an icon.

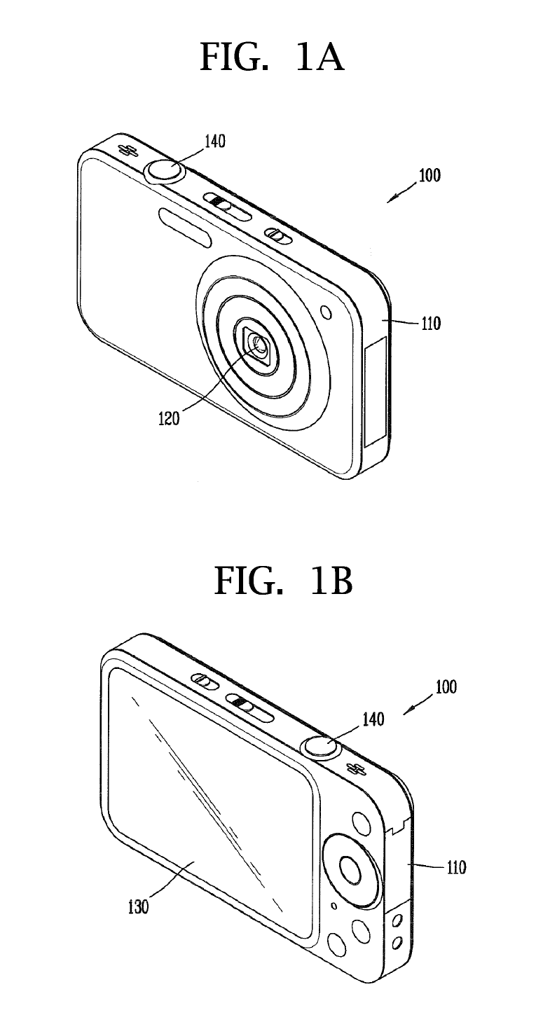

### DETAILED DESCRIPTION OF THE INVENTION

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

Furthermore, a suffix “module” or “unit” used for constituent elements disclosed in the following description is merely intended for easy description of the specification, and the suffix itself does not give any special meaning or function.

Hereinafter, the embodiments disclosed herein will be described in detail with reference to the accompanying drawings, and the same or similar elements are designated with the same numeral references regardless of the numerals in the drawings and their redundant description will be omitted.

In describing the embodiments disclosed herein, moreover, the detailed description will be omitted when a specific description for publicly known technologies to which the invention pertains is judged to obscure the gist of the present invention. In addition, it should be noted that the accompanying drawings are merely illustrated to easily explain the spirit of the invention, and therefore, they should not be construed to limit the technological spirit disclosed herein by the accompanying drawings.

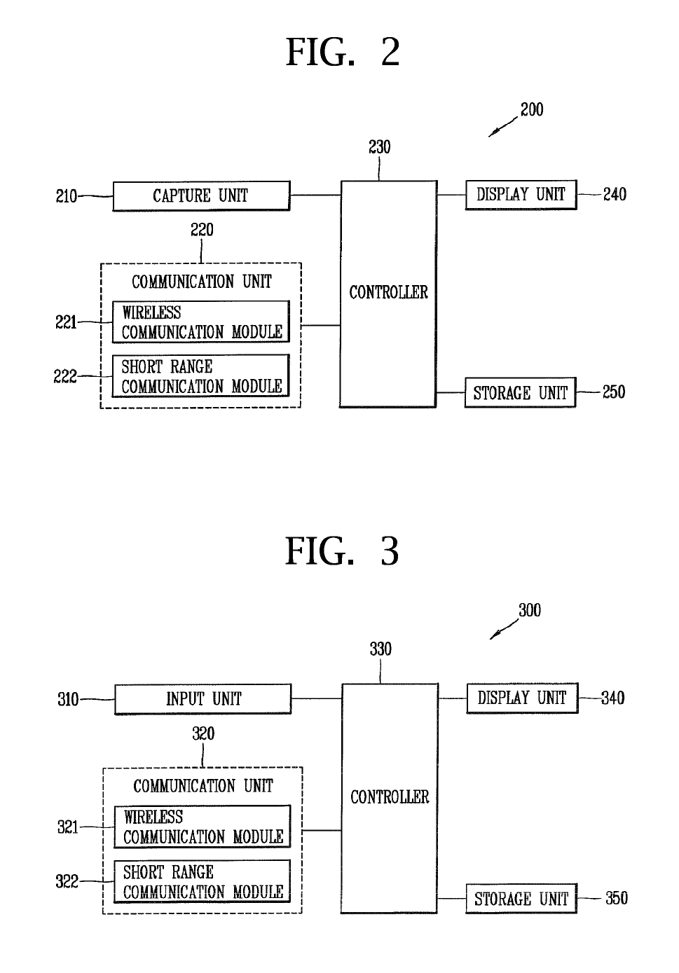

FIG. 2 is a block diagram illustrating a camera 200 according to an embodiment disclosed herein. Referring to FIG. 2, the camera 200 includes a capture unit 210, a communication unit 220, a controller 230, and a display unit 240.

The capture unit 210 captures an object as an image, and includes a lens, a flash, an iris, a shutter, and the like. The capture unit 210 may process taken images such as a picture captured by a lens and the like. If an input for image taking is generated by the controller 230 or the like, the capture unit 210 takes an image captured by the lens and transmits it to the controller 230.

A picture captured or an image taken by the lens may be displayed on the display unit 240. Alternatively, an image captured by the capture unit 210 may be stored in the storage unit 250 or transmitted to the outside through the communication unit 220.

The communication unit 220 performs wired or wireless data communication. The communication unit 220 may include an electronic component for at least any one of Bluetooth™, Zigbee, Ultra Wide Band (UWB), Wireless USB, Near Field Communication (NFC), and Wireless LAN.

The communication unit 220 may include one or more modules allowing communication between the camera 200 and a network in which the camera 200 is located or between the camera 200 and the terminal 300. For example, in FIG. 2, the communication unit 220 includes a wireless communication module 221, a short-range communication module 222, and the like.

The wireless communication module 221 refers to a module for wireless communication access, which may be internally or externally coupled to the camera 200. Examples of such wireless communication access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module 222 refers to a module for short-range communications. Suitable technologies for implementing this module may include Bluetooth, Radio Frequency IDentification (RFID), Infrared Data Association (IrDA), Ultra-WideBand (UWB), ZigBee, and the like. On the other hand, Universal Serial Bus (USB), IEEE 1394, Thunderbolt of Intel technology, and the like, may be used for wired short-range communications.

According to an embodiment disclosed herein, the communication unit 220 establishes a connection for wireless communication using the communication technologies together with the terminal 300 located in a near field region.

Furthermore, according to an embodiment disclosed herein, the communication unit 220 can transmit a picture being captured through the capture unit 210 to the terminal 300. In addition, the communication unit 220 can transmit image data generated by taking the picture to the terminal 300. At this time, the camera 200 can transmit the data by compressing or converting it into an image having a resolution lower than a resolution supported by the camera 200. The low resolution is a resolution supported by the terminal 300 to allow the terminal 300 having a resolution lower than that of the camera 200 to receive the received image with no delay or distortion. The camera 200 may include an image conversion module separately for compressing or converting an image to change a resolution of the image.

Furthermore, according to an embodiment disclosed herein, the communication unit 220 can receive an input for controlling the camera 200 from the terminal 300. The input may be an input for selecting a partial region within the entire region of the image, an input for changing a capture mode or an input for instructing the taking of the image including a shutter speed of the camera 200, an aperture value, and light sensitivity information (ISO), whether to use a flash, zoom-in/zoom-out of a lens, camera filter selection, and whether to use a special effect. Furthermore, the input may be an input for turning on/off the power of the camera 200.

The controller 230 can also control an entire operation of the camera 200. For example, the controller 230 may control the camera 200 to perform communication with the terminal 300, and control the taking of pictures with the camera 200.

According to an embodiment disclosed herein, the controller 230 may control the communication unit 220 to transmit a picture being captured through the capture unit 210 or image data to the terminal 300. Alternatively, the controller 230 may control the communication unit 220 to receive an input for controlling the taking of the camera 200 from the terminal 300.

According to an embodiment disclosed herein, the controller 230 can control the display unit 240 to display a picture being captured through the capture unit 210 or image data generated by taking the picture. Furthermore, the controller 230 can control the storage unit 250 to store the image data in the storage unit 250. At this time, the controller 230 may generate only a partial region selected by the terminal 300 within the entire region of the image as image data to store it in the storage unit 250.

Furthermore, the controller 230 may recognize a specific object from an image being captured through the capture unit 210 and control the display unit 240 to indicate and display it. At this time, the specific object recognized by the controller 230 may be a human face.

The display unit 240 may display (output) information being processed by the camera 200. When the camera 200 performs a picture capture and image taking operation through the capture unit 210, a user interface (UI) or graphic user interface (GUI) associated with this will be displayed thereon.

According to an embodiment disclosed herein, the display unit 240 may display the picture being captured through the capture unit 210 or the image data generated by taking the image. Furthermore, the display unit 240 may recognize a specific object from the picture being captured and then indicate and display it. The specific object may be a human face, and in this instance the recognition and display of the specific object may be shown as a function such as person recognition, smile recognition, and the like.

The display unit 240 may include at least one of a liquid crystal display (LCD), a thin film transistor-liquid crystal display (TFT-LCD), an organic light-emitting diode (OLED), a flexible display, a three-dimensional (3D) display, or the like. When the display unit 240 and a sensor for detecting a touch operation (hereinafter, referred to as a “touch sensor”) have a layered structure therebetween (hereinafter, referred to as a “touch screen”), the display unit 240 may be used as an input device rather than an output device. The touch sensor may be implemented as a touch film, a touch sheet, a touch pad, and the like.

The touch sensor may be configured to convert changes of a pressure applied to a specific part of the display unit 240, or a capacitance occurring from a specific part of the display unit 240, into electric input signals. The touch sensor may be configured to detect not only a touched position and a touched area but also a touch pressure.

When there is a touch input to the touch sensor, the corresponding signals are transmitted to a touch controller. The touch controller processes the signals, and then transmits the corresponding data to the controller 230. As a result, the controller 230 may sense which region of the display unit 240 has been touched.

Furthermore, the camera 200 according to an embodiment disclosed herein may further include a storage unit 250. The storage unit 250 may store a program for implementing the operation of the controller 230. Alternatively, the storage unit 250 may temporarily store input/output data (for example, images, videos, and others).

The storage unit 250 may store software components including an operating system, a module performing a function of the communication unit 220, a module operated together with the capture unit 210, a module operated together with the display unit 240. The operating system (for example, LINUX, UNIX, OS X, WINDOWS, Chrome, Symbian, iOS, Android, VxWorks or other embedded operating systems) may include various software components and/or drivers for controlling system tasks such as memory management, power management, and the like.

Furthermore, the storage unit 250 may store a set-up program associated with data communication or image taking. The set-up program may be implemented by the controller 230. The storage unit 250 may include at least any one of a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like.

According to an embodiment disclosed herein, the storage unit 250 may store image data generated by taking a picture being captured through the capture unit 210. At this time, the storage unit 250 may store image data generated only with a partial region selected from the terminal 300 within the entire region of the image.

The constituent elements of the camera 200 illustrated in FIG. 2 may not be necessarily required, and the camera 200 may be implemented with a greater or less number of elements than those illustrated in FIG. 2.

Next, FIG. 3 is a block diagram illustrating the terminal 300 according to an embodiment disclosed herein. Referring to FIG. 3, the terminal 300 includes an input unit 310, a communication unit 320, a controller 330, and a display unit 340.

The input unit 310 can generate input data to control an operation of the terminal. The input unit 310 may include a keypad, a dome switch, a touch pad (pressure/capacitance), a jog wheel, a jog switch, and the like.

According to an embodiment disclosed herein, the input unit 310 may generate an input for controlling the taking of the camera 200. The input may be an input for selecting a partial region within the entire region of the image, an input for changing a capture mode or an input for instructing the taking of the image including a shutter speed of the camera 200, an aperture value, and light sensitivity information (ISO), whether to use a flash, zoom-in/zoom-out of a lens, camera filter selection, and whether to use a special effect.

Furthermore, the input may be an input for turning on/off the power of the camera 200. In this instance, the input may be generated by the start (drive)/termination of a program or application for controlling the camera 200.

The communication unit 320 performs wired or wireless data communication. The communication unit 320 includes an electronic component for at least any one of Bluetooth™, Zigbee, Ultra Wide Band (UWB), Wireless USB, Near Field Communication (NFC), and Wireless LAN.

The communication unit 320 may include one or more modules allowing communication between the terminal 300 and a network in which the terminal 300 is located or between the terminal 300 and the camera 200. For example, in FIG. 3, the communication unit 320 includes a wireless communication module 321, a short-range communication module 322, and the like. The function of the wireless communication module 321 and the short-range communication module 322 is as described above.

According to an embodiment disclosed herein, the communication unit 320 can receive a picture captured through the capture unit 210 or image data from the camera 200. At this time, the terminal 300 may compress or convert the captured picture or image data that has been received to have a resolution lower than a resolution supported by the camera 200. The low resolution is a resolution supported by the terminal 300 to allow the terminal 300 having a resolution lower than that of the camera 200 to process and display the received image with no delay or distortion. The terminal 300 may include an image conversion module separately for compressing or converting an image to change a resolution of the image.

Furthermore, according to an embodiment disclosed herein, the communication unit 320 may transmit an input for controlling the taking of the camera 200 to the camera 200. The controller 330 may also control an entire operation of the terminal 300. For example, the controller 330 may control the terminal 300 to perform communication with the camera 200, and control the taking an image with the camera 200.

According to an embodiment disclosed herein, the controller 330 can detect the generation of an input through the input unit 310, and determine that the input is an input for performing which command. Furthermore, according to an embodiment disclosed herein, the controller 330 can control the communication unit 320 to receive a picture being captured through the capture unit 210 or image data from the camera 200. Alternatively, the controller 330 can control the communication unit 320 to transmit an input to the camera 200 for controlling the taking of an image using the camera 200.

According to an embodiment disclosed herein, the controller 330 can control the display unit 340 to display a picture or image data received from the camera 200. Furthermore, the controller 330 can control a storage unit 350 to store the image data in the storage unit 350.

The display unit 340 can display (output) information being processed by the terminal 300. When the terminal 300 performs communication for capture control with the camera 200, a user interface (UI) or graphic user interface (GUI) associated with capture control is preferably displayed.

According to an embodiment disclosed herein, the display unit 340 can display picture or image data received from the camera 200. Furthermore, the display unit 340 may display only a partial region corresponding to a pixel size supported by the display unit 340 to be stored in the camera after taking the image within the entire region of the received image. At this time, the display unit 340 can display a partial region included in a specific object recognized by the camera 200. The specific object may be a human face.

Furthermore, according to an embodiment disclosed herein, the display unit 340 can display a user interface (UI) for generating an input for vertically or horizontally moving the image to select the partial region, or a user interface (UI) for generating an input for changing a capture mode including a shutter speed of the camera 200, an aperture value, and light sensitivity information (ISO), whether to use a flash, zoom-in/zoom-out of a lens, camera filter selection, and whether to use a special effect.

The display unit 340 may include at least one of a liquid crystal display (LCD), a thin film transistor-liquid crystal display (TFT-LCD), an organic light-emitting diode (OLED), a flexible display, a three-dimensional (3D) display, or the like. Some of those displays may be configured with a transparent or optical transparent type to allow the user to view the outside through the display unit, which may be called transparent displays. An example of the typical transparent displays may include a transparent OLED (TOLED), and the like. The rear structure of the display unit 340 may be also configured with an optical transparent structure. Under this configuration, the user can view an object positioned at a rear side of the terminal body through a region occupied by the display unit 340 of the terminal body.

Two or more display units 340 may be implemented according to the implementation type of the terminal 300. For example, a plurality of the display units 340 may be disposed on one surface in a separated or integrated manner, or disposed on different surfaces from one another.

When the display unit 340 and a sensor for detecting a touch operation (hereinafter, referred to as a “touch sensor”) have an interlayer structure (hereinafter, referred to as a “touch screen”), the display unit 340 may be used as an input device rather than an output device. When the display unit 340 is used as an input device, the operation of the display unit 340 is as described above.

Furthermore, the terminal 300 according to an embodiment disclosed herein may further include the storage unit 350. The storage unit 350 may store a program for implementing the operation of the controller 330. Alternatively, the storage unit 350 may temporarily store input/output data (for example, phonebooks, messages, images, videos, and others).

Furthermore, the storage unit 350 may store a set-up program associated with data communication or capture control. The set-up program may be implemented by the controller 330. Furthermore, the storage unit 350 may store a capture control application of the camera 200 downloaded from an application providing server (for example, app store). The wireless power transmission related application is a program for controlling wireless power transmission, and the terminal 300 may receive a captured picture or taken image from the camera 200 through the relevant program, or control the taking of the camera 200.

According to an embodiment disclosed herein, the storage unit 350 may store image data received from the camera 200. In addition, the configuration of the storage unit 350 is as described above. The constituent elements of the terminal 300 illustrated in FIG. 3 may not be necessarily required, and the terminal 300 may be implemented with a greater or less number of elements than those illustrated in FIG. 3.

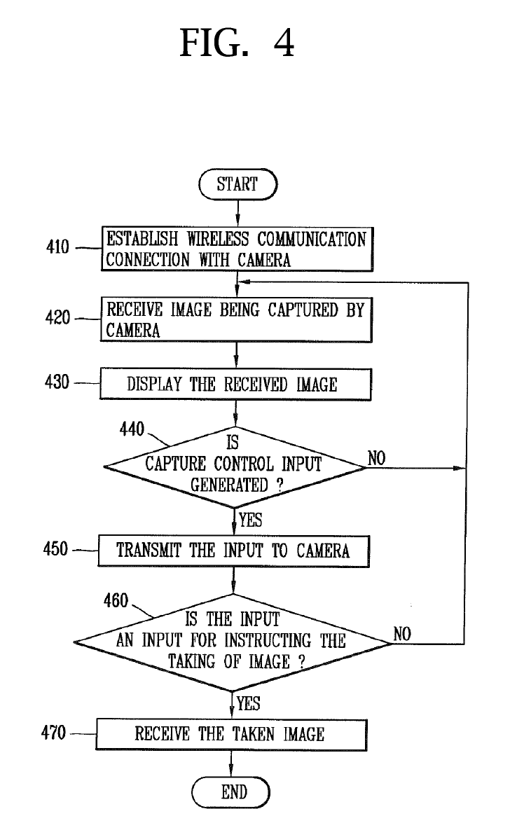

Next, FIG. 4 is a flow chart illustrating a camera control method using a terminal according to an embodiment disclosed herein. Referring to FIG. 4, first, the terminal 300 establishes a connection for wireless communication with the camera 200 (S410).

The terminal 300 may first establish a connection for communication with the camera 200 located in a near field region through the communication unit 320. The terminal 300 may establish a connection to the camera 200 using wireless communication technologies such as Wi-Fi, Wibro, Wimax, and the like or short-range communication technologies such as Bluetooth, and the like.

In particular, the terminal 300 may establish a connection for performing communication in real time with the camera 200 using Wi-Fi Direct Technology. In general, the data transmission speed of Bluetooth is maximum 24 Mbps whereas the data transmission speed of Wi-Fi Direct is maximum 300 Mbps. If data is compressed and transmitted to reduce a transmission amount by corresponding to the maximum transmission speed when the camera 200 transmits data to the terminal 300, then real time may be reduced. Accordingly, Wi-Fi Direct Technology may be beneficial to transmit the information amount of image data in real time with no compression.

The terminal 300 can search the camera 200 located within a near distance or transmit and receive data for identifying the camera 200. The near distance may refer to the locations of cameras within a single room, within a single floor, within a single building, within a predetermined distance (e.g., 10 m, 20 m, 30 m), or the like. The near distance generally depends on whether the terminal 300 can successfully transmit and receive communication to/from the camera 200 when the camera 200 is located within that distance. However, in an alternative embodiment, the user can set a “near distance” value so the terminal 300 only searches for and communicates with a camera within the user-defined “near distance.” Thus, the user can selectively set what value the “near distance” should be.

In still another embodiment, if the terminal 300 finds multiple cameras 200, the terminal can display or output a prompt asking the user to select one or more cameras 200 among the multiple cameras 200. Next, the terminal 300 receives a picture being captured by the camera 200 (S420).

The terminal 300 can receive a picture currently being captured by the camera 200 through the communication unit 320. In particular, the camera 200 can convert the picture into data, and transmit the converted data to the terminal 300 using a frequency bandwidth supported by the communication technology. The terminal 300 can also inverse-convert the received data to acquire a picture being captured by the camera 200.

Furthermore, the terminal 300 may receive a picture compressed or converted into an image having a resolution lower than a resolution supported by the camera 200. Alternatively, the terminal 300 may compress and convert the received picture into a picture having a resolution lower than that of the received picture. In this instance, the terminal 300 may include a picture conversion module separately for compressing or converting the picture. The low resolution is a resolution supported by the terminal 300 to allow the terminal 300 having a resolution lower than that of the camera 200 to receive the picture with no delay or loss or display the picture with no distortion.

Subsequently, the terminal 300 displays the picture received from the camera 200 (S430). The terminal 300 can display the received picture through the display unit 340. In this instance, the displayed image may have a lower resolution than the received picture. In other words, the resolution supported by the terminal 300 is lower than that is supported by the camera 200, so the picture displayed on display of the terminal 300 may have a lower resolution than the picture received from the camera 200. For this, the terminal 300 can convert the received picture to lower resolution.

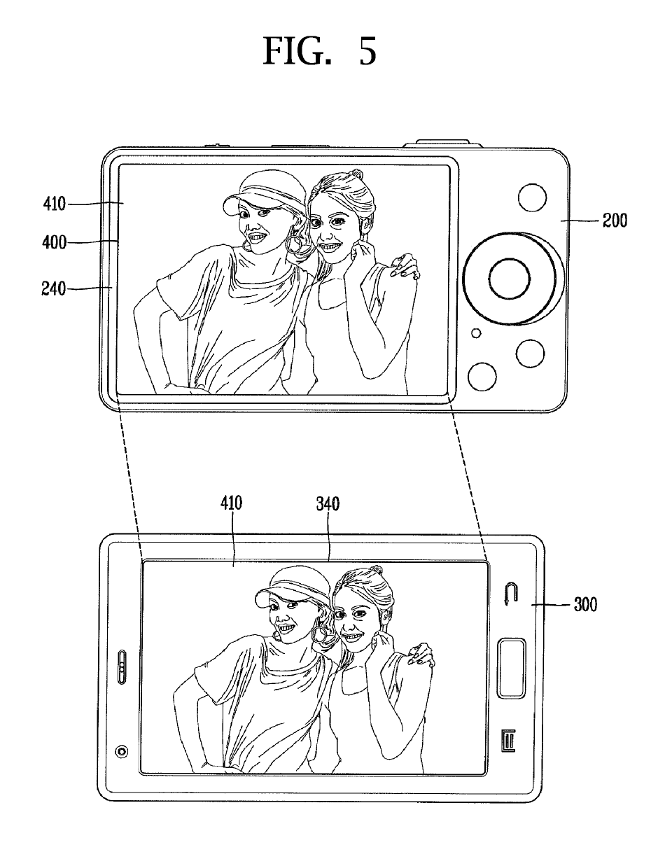

According to an embodiment disclosed herein, as illustrated in FIG. 5, the terminal 300 may display only a partial region 410 corresponding to a pixel size supported by the display unit 340 among the entire region 400 of the received picture. The partial region may indicate a selected region desired by the user to be generated as image data in the camera 200 after taking the picture within the entire region 400 of the picture.

In other words, the user may select and store only the partial region 410 desired to be taken within the entire region 400 even though the camera 200 is not moved in a separate manner when taking a picture in a self-camera mode, thereby allowing the terminal 300 to obtain an effect of taking a picture with the right composition. Furthermore, the user may obtain an effect of moving the camera 200 to locate his or her desired object at the center of the picture when performing self-camera composition.

Furthermore, the terminal 300 may first display a partial region including a specific object recognized by the camera 200 within the received picture. At this time, the specific object may be a human face. In other words, for the sake of the user's convenience, the terminal 300 may first display a partial region including a specific object recognized by the camera 200 based on the information of the picture transmitted from the camera 200, thereby allowing the user to minimize an input operation for moving a partial region. For example, when the specific object is a human face, the terminal 300 may first display a region including the human face within the entire region of the picture, thereby guiding the user to select and take the partial region.

As a result, the user may perform a self-capture operation for a portrait having the right composition without checking the display unit 240 of the camera 200 while minimizing an input operation for selecting the partial region.

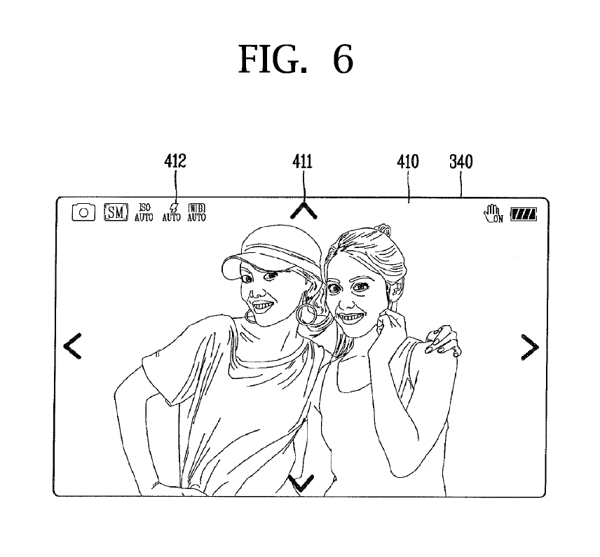

When displaying the received picture, the terminal 300 may display a UI as illustrated in FIG. 6 to receive an input for capture control from the user in addition to the received picture. In other words, the terminal 300 may display the relevant UI 411 together therewith to select the partial region 410 by vertically or horizontally moving it. Furthermore, the terminal 300 may display the relevant UI 412 together therewith to receive an input for capture mode control of the camera 200.

Then, the terminal 300 checks whether an input for capture control is generated by the user (S440). The terminal 300 may check whether the user generates an input for capture control of the camera 200 through the input unit 310. When the input is not generated, the terminal 300 may continuously receive a picture being captured from the camera 200 using communication connected therewith.

When an input for capture control is generated (Yes in S440), the terminal 300 transmits the input to the camera 200 (S450). The terminal 300 may transmit data including the input information to the camera 200 through the input unit 310.

According to an embodiment disclosed herein, the input may be an input for vertically or horizontally moving the displayed image to select the partial region within the entire region of the received picture. Alternatively, the input may be an input for performing various manipulations such as enlarging and reducing the selected region, changing a shape of the selected region, or the like to select a partial region within the entire region of the received picture.

Furthermore, according to an embodiment disclosed herein, the input is an input for changing a capture mode including a shutter speed indicating a time for which the iris of the camera 200 is open, an aperture value indicating the width information of the aperture for adjusting an amount of light passing through the lens, and light sensitivity information (International Organization for Standardization, ISO) indicating a sensitivity to light, whether to use a flash which is an auxiliary lighting device, zoom-in/zoom-out adjustment of a lens, camera filter selection, and whether to use a special effect. Alternatively, the input may be an input for instructing the camera 200 to take the received picture and generate image data.

At this time, when the input indicates an image taking of the partial region selected by the user within the entire region of the received picture, the camera 200 may control the zoom-in/zoom-out of the camera 200 to allow the capture unit 210 to capture and take only the partial region. If the capture unit 210 captures only the partial region, then the camera 200 may perform an image taking of the partial region to generate image data.

Otherwise, the camera 200 may take an entire region of the picture being captured by the capture unit 210, and then crop the partial region to generate and store image data. Furthermore, the input may be an input for turning on/off the power of the camera 200. In this instance, the input may be generated by the start (drive)/termination of a program or application for controlling the camera 200.

Furthermore, the terminal 300 checks whether the input is an input for instructing the taking of the received picture (S460). When the input is an input for instructing the taking of the received picture (Yes in S460), the terminal 300 receives a taken image from the camera 200 (S470).

The terminal 300 instructs the camera 200 to take the received picture (same as the captured picture), and receives image data that the camera 200 actually takes the picture and generates, and thus the terminal 300 can directly check it. Further, the received image data is data compressed or converted by corresponding to a resolution of the terminal 300 supporting a resolution lower than that of the camera 200.

The terminal 300 may also store the received image data in the terminal 300. Furthermore, the terminal 300 may store or delete the image data and then continuously receive an image being captured from the camera 200, thereby performing an image recapture operation.

The camera control method using a terminal may be typically performed by the process illustrated in FIG. 4, but some of the constituent elements and implementation processes may be modified within the scope that can be implemented by those skilled in the art.

It will be apparent to those skilled in this art that various changes and modifications may be made thereto without departing from the gist of the present invention. Accordingly, it should be noted that the embodiments disclosed in the present invention are only illustrative and not limitative to the spirit of the present invention, and the scope of the spirit of the invention is not limited by those embodiments. The scope protected by the present invention should be construed by the accompanying claims, and all the spirit within the equivalent scope of the invention should be construed to be included in the scope of the right of the present invention.

What is claimed is:

1. A method of controlling a mobile terminal, the method comprising:
establishing a wireless communication connection with an external camera located at a near distance from the mobile terminal;
receiving, by the mobile terminal and from the external camera, a preview picture generated by the external camera;
displaying, on a display unit of the mobile terminal, the preview picture generated by the external camera;
receiving an input on the mobile terminal for commanding the external camera to perform a predetermined camera function; and
transmitting, by the mobile terminal, the input to the external camera for commanding the external camera to perform the predetermined camera function.

2. The method of claim 1, wherein the preview picture displayed on the mobile terminal has a resolution lower than a resolution of the preview picture generated by the external camera.

3. The method of claim 1, wherein the preview picture received from the external camera is compressed or converted from a resolution supported by the external camera into a resolution supported by the mobile terminal.

4. The method of claim 1, wherein said displaying the received picture on the display unit of the mobile terminal displays only a partial region of the preview picture generated by the external camera corresponding to a pixel size supported by the display unit of the mobile terminal.

5. The method of claim 4, wherein the received input is for vertically or horizontally moving the displayed preview picture to select the partial region within an entire region of the received picture.

6. The method of claim 1, wherein the received input is for commanding the external camera for changing a capture mode including a shutter speed of the camera, an aperture value, and light sensitivity information (ISO).

7. The method of claim 1, wherein the received input is for commanding the external camera to capture the preview picture.

8. The method of claim 7, further comprising:
receiving, by the mobile terminal from the external camera, the image captured by the external camera.

9. A mobile terminal, comprising:
a wireless communication unit configured to establish a wireless communication connection with an external camera located at a near distance from the mobile terminal, and to receive a preview picture generated by the external camera;
a display unit configured to display the preview picture generated by the external camera; and
a controller configured to receive an input for commanding the external camera to perform a predetermined camera function, and to transmit the input to the external camera for commanding the external camera to perform the predetermined camera function.

10. The mobile terminal of claim 9, wherein the controller is further configured to display the preview picture on the display unit of the mobile terminal to have a resolution lower than a resolution of the preview picture generated by the external camera.

11. The mobile terminal of claim 9, wherein the preview picture received from the external camera is compressed or converted from a resolution supported by the external camera into a resolution supported by the mobile terminal.

12. The mobile terminal of claim 9, wherein the controller is further configured to display only a partial region of the preview picture generated by the external camera corresponding to a pixel size supported by the display unit of the mobile terminal.

13. The mobile terminal of claim 12, wherein the received input is one of: 1) for vertically or horizontally moving the displayed preview picture to select the partial region within an entire region of the received picture, 2) for commanding the external camera for changing a capture mode including a shutter speed of the camera, an aperture value, and light sensitivity information (ISO), or 3) for commanding the external camera to capture the preview picture.

14. The mobile terminal of claim 13, wherein the controller is further configured to receive the picture captured by the external camera.

15. A method of controlling a camera, the method comprising:
establishing a wireless communication connection with an external mobile terminal located at a near distance from the camera;
generating a preview picture using a lens of the camera;
transmitting the generated preview picture to the external mobile terminal so the external mobile terminal displays the preview picture;
receiving an input transmitted from the mobile terminal for performing a predetermined camera function; and
performing the predetermined camera function.

16. The method of claim 15, wherein the preview picture displayed on the external mobile terminal has a resolution lower than a resolution of the preview picture generated by the camera.

17. The method of claim 15, further comprising:
compressing or converting the preview image from a resolution supported by the camera into a resolution supported by the external mobile terminal before transmitting the generated preview picture to the external mobile terminal.

18. The method of claim 15, wherein only a partial region of the preview picture generated by the camera corresponding to a pixel size supported by the mobile terminal is displayed on the mobile terminal.

19. The method of claim 18, wherein the received input is for vertically or horizontally moving the displayed preview picture to select the partial region within an entire region of the received picture.

20. The method of claim 15, wherein the received input is one of: 1) for vertically or horizontally moving the displayed preview picture to select the partial region within an entire region of the received picture, 2) for commanding the external camera for changing a capture mode including a shutter speed of the camera, an aperture value, and light sensitivity information (ISO), or 3) for commanding the external camera to capture the preview picture.
